(19) United States
(12) Patent Application Publication
(10) Pub. No.: US 2011/0320980 A1
(43) Pub. Date: Dec. 29, 2011

(54) Electronic Device for Providing a Visual Representation of a Widget Associated with a Contacts Database

(75) Inventors: Anthony D. Hand, Chicago, IL (US); Enrique Sanchez, JR., Franklin Park, IL (US)

(73) Assignee: Motorola, Inc., Schaumburg, IL (US)

(21) Appl. No.: 12/821,702

(22) Filed: Jun. 23, 2010

(51) Int. Cl. G06F 3/048

(52) U.S. Cl. 715/828; 715/810

(57) ABSTRACT

There is disclosed a method of an electronic device for providing a visual representation of a contact widget, in which the electronic device includes a display and an input component associated with the display. A display provides a contact widget including positions for task representations. An input component then detects selection of a particular position of the contact widget. Next, the input component detects selection of a particular task of a contact list associated with the contact widget. Thereafter, the display provides a representation of the particular task at the particular position.

### RELATED APPLICATIONS

This application is related to U.S. application Ser. No. ______, filed Jun. 23, 2010, titled ELECTRONIC DEVICE FOR PROVIDING A VISUAL REPRESENTATION OF A RESIZABLE WIDGET ASSOCIATED WITH A CONTACTS DATABASE (Attorney Docket No. CS37788); U.S. application Ser. No. 12/556,776, filed Sep. 10, 2009, titled PORTABLE ELECTRONIC DEVICE FOR PROVIDING A VISUAL REPRESENTATION OF A WIDGET (Attorney Docket No. CS37220), and U.S. application Ser. No. 12/556,783, filed Sep. 10, 2009, titled WIRELESS COMMUNICATION DEVICE FOR PROVIDING A VISUAL REPRESENTATION OF A WIDGET (Attorney Docket No. CS37221).

### FIELD OF THE INVENTION

The present invention relates generally to the field of portable electronic devices and, more particularly, to the field of a portable electronic device having a display for providing widgets.

### BACKGROUND OF THE INVENTION

A portable electronic device is capable of interacting with a user and transportable due to its diminutive size and portable power supply. An example of a portable electronic device is a wireless communication device, which provides long-range communication of voice or data over a communication network of specialized base stations to other communication devices remote from the wireless communication device. Portable electronic devices come in a variety of form factors, such as brick, bar, flip/clamshell, slider or rotator/swivel form factors, and each form factor can have a touchscreen or QWERTY keypad. Regardless of the small form factor, the device generally includes a display to convey information to a user or otherwise facilitate the user's use and enjoyment of the device.

Displays of portable electronic devices may provide a variety of visual objects, and one type of visual object is a widget. Widgets are interactive virtual tools that provide single-purpose services, such as providing the user the news, weather, time, calendar, or other single-purpose information. On a portable electronic device, widgets provide a user of the device high level snippets of information at a glance. A widget may include an image or icon to aid the user's comprehension of the information. The challenge is providing an informative widget within a minimal area of the display, due to the diminutive size of the device.

### BRIEF DESCRIPTION OF THE DRAWINGS

FIG. 1 is a top planar view of an embodiment in accordance with the present invention, in which the embodiment is shown in its open configuration.

FIG. 2 is a block diagram of example components of the embodiment of FIG. 1.

FIG. 3 is a screen view providing an example home screen in accordance with the present invention.

FIGS. 4A through 4E are screen views illustrating an example storyboard for inserting a contact widget in accordance with the present invention.

FIG. 5 is a flow diagram representing the example storyboard of FIGS. 4A through 4E.

FIG. 6A through 6D are screen views illustrating an example storyboard for resizing another contact widget in accordance with the present invention.

FIG. 7 is a flow diagram representing the example storyboard of FIGS. 6A through 6D.

FIG. 8A through 8I are screen views illustrating example contact widget specifications in accordance with the present invention.

FIG. 9A through 9D are screen views illustrating example visual representations of other contact widgets in accordance with the present invention.

FIG. 10A through 10D are screen views illustrating an example storyboard for setting a widget action of another contact widget in accordance with the present invention.

FIG. 11 is a flow diagram representing the example storyboard of FIGS. 10A through 10D.

FIGS. 12A through 12C are screen views illustrating an example storyboard for making a call in accordance with the present invention.

FIG. 13 is a flow diagram representing the example storyboard of FIGS. 12A through 12C.

### DETAILED DESCRIPTION OF THE EMBODIMENTS

One aspect of the present invention is a method of an electronic device for providing a visual representation of a contact widget, wherein the electronic device includes a display and an input component associated with the display. A display displays a contact widget including a plurality of positions for task representations. An input component then detects selection of a particular position of the contact widget. Next, the input component detects selection of a particular task of a contact list associated with the contact widget. Thereafter, the display displays a representation of the particular task at the particular position.

Another aspect of the present invention is an electronic device for providing a visual representation of a contact widget comprising a display supported by the device, a memory supported by the device, and a processor coupled to the display and the memory. The display provides the contact widget including a task representation. The memory stores a contact associated with the contact widget, in which the task representation corresponds to a task of the contact. The processor updates the task representation in response to determining that the task of the contact corresponding to the task representation has been changed.

Yet another aspect of the present invention is a method of an electronic device that displays, at a display, a contact widget including positions for task representations. Each task representation is associated with a priority. The task representations are sorted in a particular order based on the priorities of the task representations relative to each other.

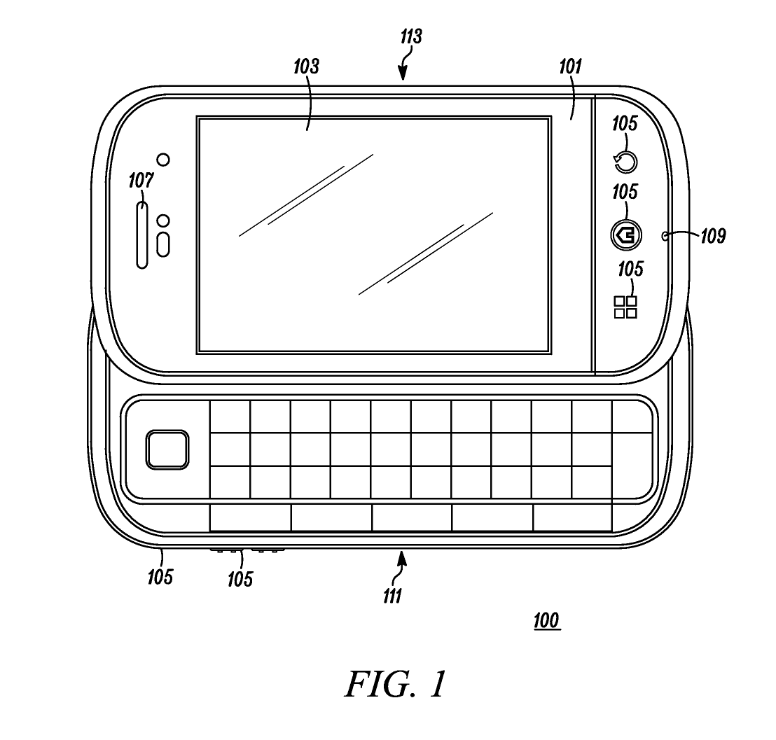

Referring to FIG. 1, there is illustrated a perspective view of an example portable electronic device 100 in accordance with the present invention. The device 100 may be any type of device capable of providing a visual representation of a widget. Examples of the portable electronic device 100 include, but are not limited to, cellular-based mobile phones, WLAN-based mobile phones, personal digital assistants, personal navigation device, touch screen input device, pen-based input devices, portable video and/or audio players, and the like.

For one embodiment, the portable electronic device 100 has a housing comprising a front surface 101 which includes a visible display 103 and a user interface. For example, the user interface may be the touch-sensitive surface that overlays the display 103. For another embodiment, the user interface of the portable electronic device 100 may include a touch-sensitive surface supported by the housing and does not overlay any type of display. For yet another embodiment, the user interface of the portable electronic device 100 may include one or more input keys 105. Examples of the input key or keys 105 include, but are not limited to, keys of an alpha or numeric keypad, a physical keys, touch-sensitive surfaces, mechanical surfaces, multipoint directional keys and side buttons 105, 111. The portable electronic device 100 may also comprise apertures 107, 109 for audio output and input at the surface. It is to be understood that the portable electronic device 100 may include a variety of different combination of displays and interfaces.

It is to be understood that the portable electronic device 100 make take the form of a variety of form factors, such as bar, tablet, flip/clam, slider and rotator form factors. For example, for the embodiment shown in FIG. 1, the portable electronic device 100 may include a first housing 111 having an upper surface, a second housing 113 having a lower surface slidably coupled to the upper surface of the first housing. As represented in FIG. 1, the device 100 is shown in a closed position. The second housing 113 is capable of sliding to a closed position relative to the first housing in which upper and lower surfaces are substantially adjacent and concealed. The device 100 may also open to an open position. The second housing 113 is capable of sliding to an open position relative to the first housing 111 in which only a portion of the upper and lower surfaces are adjacent and concealed and the remainders of the upper and lower surfaces are offset and exposed. For another embodiment, the second housing may support a display, a first user interface, an audio input, and an audio output, and the first housing may support a second user interface and a wireless transceiver.

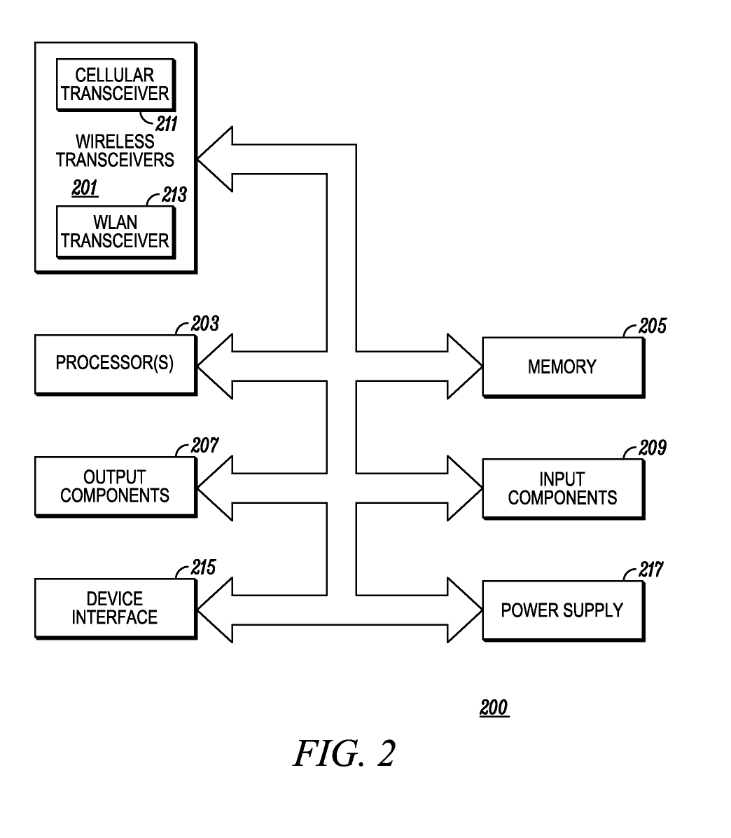

Referring to FIG. 2, there is shown a block diagram representing example components that may be used for an embodiment in accordance with the present invention. The example embodiment may includes one or more wireless transceivers 201, one or more processors 203, one or more memories 205, one or more output components 207, and one or more input components 209. Each embodiment may include a user interface that comprises one or more output components 207 and one or more input components 209. Each wireless transceiver 201 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, LTE-A or IEEE 802.16) and their variants, as represented by cellular transceiver 311. Each wireless transceiver 201 may also utilize wireless technology for communication, such as, but are not limited to, peer-to-peer or ad hoc communications such as HomeRF, Bluetooth and IEEE 802.11 (a, b, g or n); and other forms of wireless communication such as infrared technology, as represented by WLAN transceiver 213. Also, each transceiver 201 may be a receiver, a transmitter or both.

The processor 203 may generate commands based on information received from one or more input components 209. The processor 203 may process the received information alone or in combination with other data, such as the information stored in the memory 205. Thus, the memory 205 of the internal components 200 may be used by the processor 203 to store and retrieve data. The data that may be stored by the memory 205 include, but is not limited to, operating systems, applications, and data. Each operating system includes executable code that controls basic functions of the portable electronic device, such as interaction among the components of the internal components 200, communication with external devices via each transceiver 201 and/or the device interface (see below), and storage and retrieval of applications and data to and from the memory 205. Each application includes executable code utilizes an operating system to provide more specific functionality for the portable electronic device. Also, the processor is capable of executing an application associated with a particular widget shown at an output component 207. Data is non-executable code or information that may be referenced and/or manipulated by an operating system or application for performing functions of the portable electronic device.

The input components 209, such as a user interface, may produce an input signal in response to detecting a predetermined gesture at an input component, such as the touch-sensitive surface substantially parallel to the display. As a result, a transceiver 201 may terminate communication with the remote device in response to the input signal from the user interface. In addition, the input components 209 may include one or more additional components, such as a video input component such as an optical sensor (for example, a camera), an audio input component such as a microphone, and a mechanical input component or activator such as button or key selection sensors, touch pad sensor, another touch-sensitive sensor, capacitive sensor, motion sensor, and switch. Likewise, the output components 207 of the internal components 200 may include one or more video, audio and/or mechanical outputs. For example, the output components 207 may include a video output component such as a cathode ray tube, liquid crystal display, plasma display, incandescent light, fluorescent light, front or rear projection display, and light emitting diode indicator. Of particular interest are displays that are capable of providing a visual representation of a widget. Other examples of output components 207 include an audio output component such as a speaker, alarm and/or buzzer, and/or a mechanical output component such as vibrating or motion-based mechanisms.

The internal components 200 may further include a device interface 215 to provide a direct connection to auxiliary components or accessories for additional or enhanced functionality. In addition, the internal components 200 preferably include a power source 217, such as a portable battery, for providing power to the other internal components and allow portability of the portable electronic device 100.

It is to be understood that FIG. 2 is provided for illustrative purposes only and for illustrating components of a portable electronic device in accordance with the present invention, and is not intended to be a complete schematic diagram of the various components required for a portable electronic device. Therefore, a portable electronic device may include various other components not shown in FIG. 2, or may include a combination of two or more components or a division of a particular component into two or more separate components, and still be within the scope of the present invention.

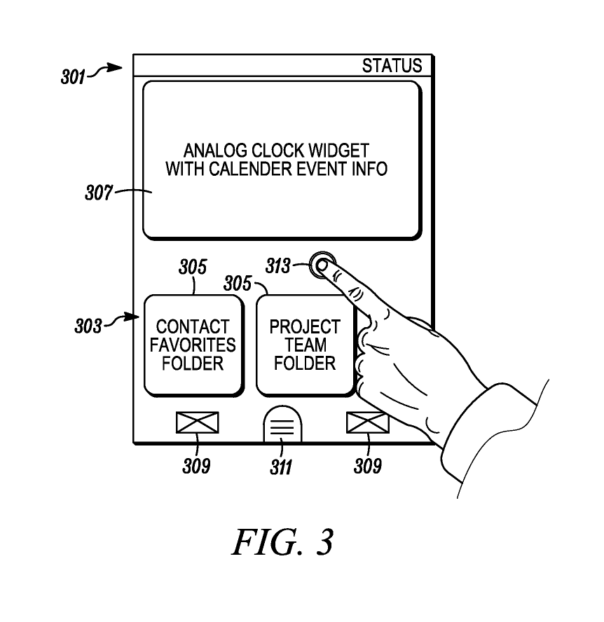

Referring to FIG. 3, there is shown a screen view providing visual representations of example widgets in accordance with the present invention. The screen view represents a front surface of an output component 207, such as a display, providing a visual representation of one or more widgets. For the embodiment shown in FIG. 3, the screen view shows a home screen, or one of multiple home screens, which is a graphical list of available applications represented by icon and/or widgets. The home screen is often a default, idle screen when a portable electronic device is powered-on and not screen locked.

The screen view may include various optional elements to facilitate a user's operation of the portable electronic device. For example, as shown in FIG. 3, the screen view may include a status bar 301, which is generally an elongated, linear portion of the screen that indicates the status of various components and/or operations of the portable electronic device. The screen view may also include an open area 303 for displaying the graphical list of available objects, such as widgets, application shortcuts, folders, etc. For example, the open area 303 may include icons or folders 305 and/or widgets 307 for activating, in part or in whole, an application stored in a memory of the portable electronic device. The screen view may further include functional buttons 309, 311 for activating particular operations of the portable electronic device, such as one or more calling functions or contacts lists, or pull-down, pull-up, or gesture-activated screens for providing additional screen views that may be utilized for more graphical lists of available applications.

For the embodiment shown in FIG. 3, the screen view includes a visual representation of a home screen of the display. A user may activate a function of adding a new widget at this home screen of the display in a variety of ways. For example, the user may press and hold at a free position 313 of the home screen. Alternatively, the user may press a menu key and select a command associated with adding an object, such as a widget, to the home screen. It is to be understood that an electronic device may have one home screen or multiple home screens, which may also be referred to as panels.

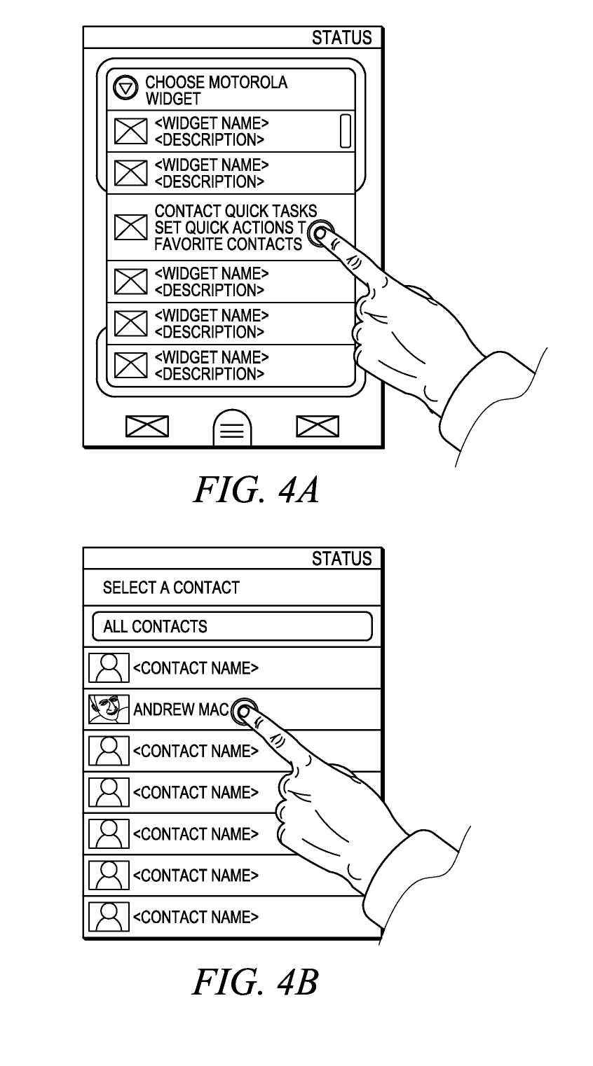

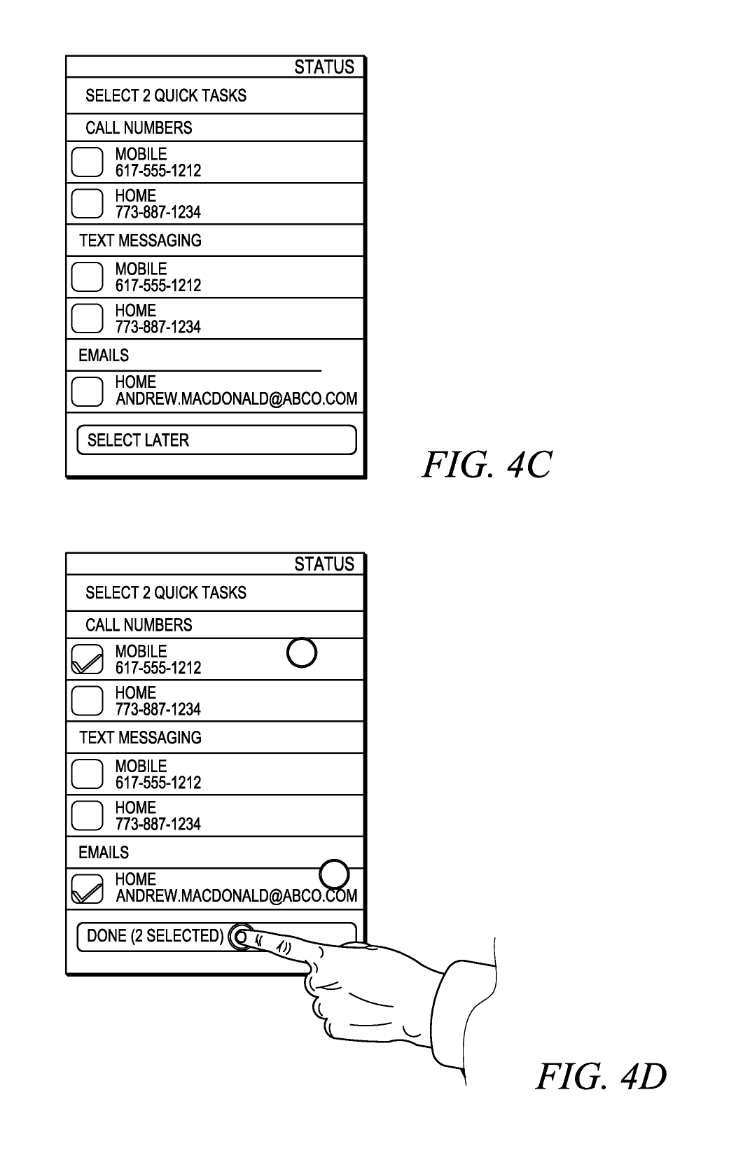

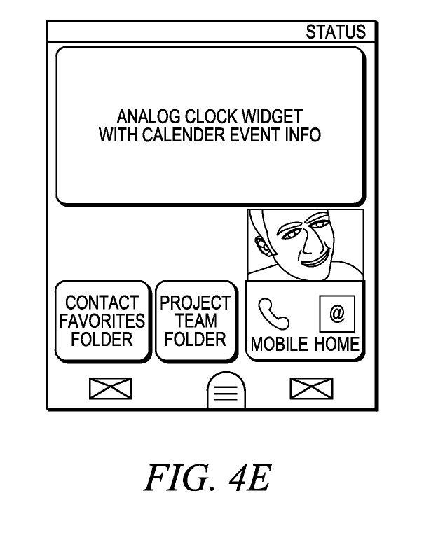

Referring to FIGS. 4A through 4E, there are shown screen views illustrating an example storyboard for inserting a contact widget at a screen in accordance with the present invention. After activating a function of adding a new widget, a user of the electronic device may add a contact widget, such as a Contact Quick Task Widget, in one of multiple ways. For example, the display of the electronic device may provide a list of object categories and/or available widgets, and the input component of the electronic device may detect selection of a representation of the contact widget, or its respective category, within the list of object categories or widgets as shown in FIG. 4A. As another example, the electronic device may provide a shortcut from another screen, such as a home screen or a menu screen, which may provide a means for adding a contact widget.

As shown in FIG. 4B, the display of the electronic device may show a list of contacts in response to detecting selection of a contact widget. The input component may detect activation of a particular contact among the list of contacts. The processor of the electronic device may then associate the particular contact with the selected contact widget. The quick task selection screen of FIG. 4C illustrates how the display may provide the tasks available for the selected contact of the contact widget. For the embodiment shown in FIG. 4C, each task may include a task identifier and a task action. Examples of task identifiers include, but are not limited to, Mobile, Home, Work, and a name of a service provider. Examples of object categories may include communication tasks and non-communication tasks. Communication tasks may include, but are not limited to, Call Numbers, Text Messages, Emails, Instant Messages (“IM”), and SMS messages. Non-communication actions may include, but are not limited to, physical addresses (such as postal addresses), contact details, communications history, viewing service provider statuses, updates and events, and actions available with a service provider. An example of an action with service providers includes, but are not limited to, an action associated with a social network integrated with one or more operations of the electronic device. For various embodiments, the communication actions may be divided or separated into communication categories. For example, as shown in FIG. 4C, the communication actions and associated communication identifiers are divided into groups identified as “Call Numbers”, “Text Messaging” and “Emails”.

As shown in FIG. 4D, the input component may detect selection by a user of one or more tasks. Instructional text on the display screen may indicate, and thus inform the user, how many selections may be made. For the embodiment shown in FIG. 4E, the text indicates, “Select 2 quick tasks”. It should be noted that the electronic device may not necessary require a user to select an exact number of communication actions; instead, the device may indicate to the user a maximum number of selections of tasks permitted. In response, the input component may detect selection of each task and provide a visual indicator to acknowledge the selection to the user, such as a mark at the left-hand side of the selected task. The electronic device may allow the user to indicate completion of selecting tasks by awaiting some type of specific user input. For the embodiment shown in FIG. 4D, the user may select the virtual button “Done (2 selected)” at the bottom of the screen. As illustrated, the device may further provide feedback to the user about the quantity of selections acknowledged by the device. Finally, the electronic device provides a new widget based on the information provided by the user above at a home screen of the display, as illustrated by FIG. 4E.

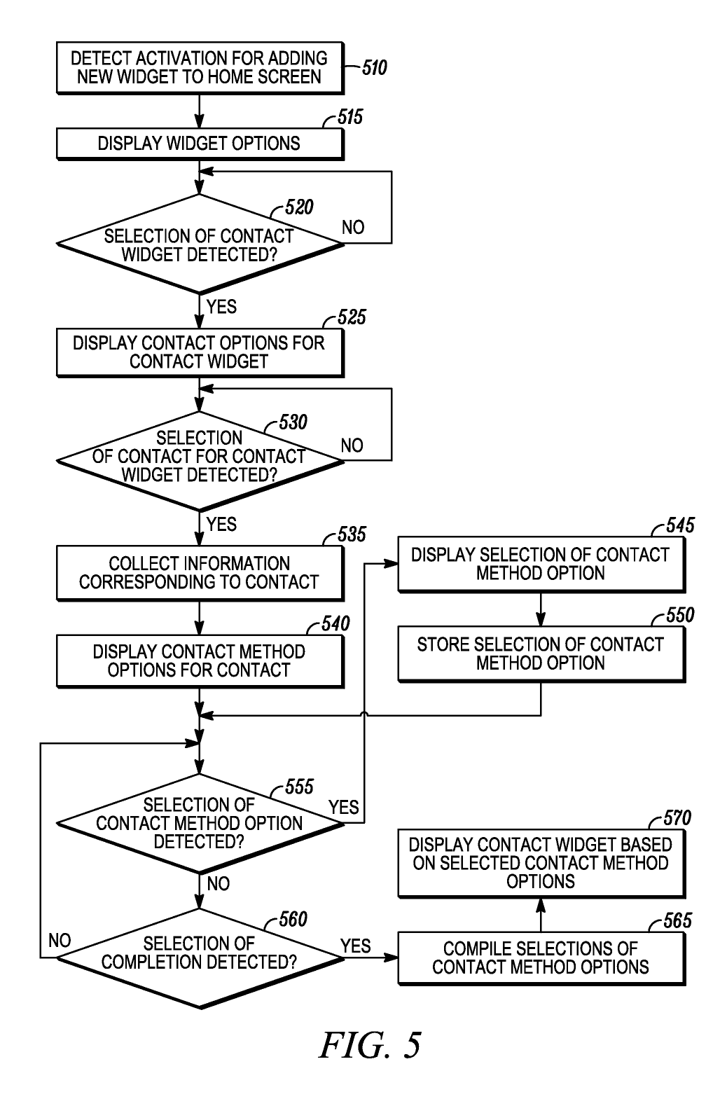

Referring to FIG. 5, there is shown a flow diagram representing the example storyboard of FIGS. 4A through 4E. Initially, the input component of the electronic device may detect activation for adding a new contact widget to a screen, such as a home screen, at step 510. The display of the electronic device may provide various options for the user to select, including a contact widget, at step 515, in response to detecting the activation. The input component may then wait for detection of a selection of the contact widget option by the user, at step 520. Upon detecting the selection, the display may provide a list of contacts to the user at step 525. For example, the display may provide the list of contacts, such as an address book and/or friend list, stored in the memory of the electronic devices for selection by the user. As another example, the transceiver of the electronic device may receive or retrieve a list of contacts from a database and/or device at a remote location. The input component may next wait for detection of a selection of a contact by the user, at step 530.

The processor of the electronic device collects or otherwise obtains information associated with the selected contact in response to user selection of the contact, at step 535. The display may then provide tasks, i.e., such as contact method options, to the user at step 540. The input component may wait for selection of tasks at step 555 and/or selection of a selection completion indicator at step 560. In response to each selection of a task, the display may re-display the list of tasks with acknowledgment indicator(s) or continue to display the list of tasks at step 545 and store the task selection of the user at step 550. Either step, 545 and 550, may occur in any order or simultaneously. In response to selection of a selection completion indicator at step 560, the processor of the electronic device may compile all task selections at step 565 and the display may provide the contact widget based on the compiled selections at step 570. The contact widget may show the task selections, as selected by the user. For example, as shown in FIG. 4E, the user may have selected tasks for Mobile and Home and, thus, representations of Mobile and Home are shown within the new contact widget.

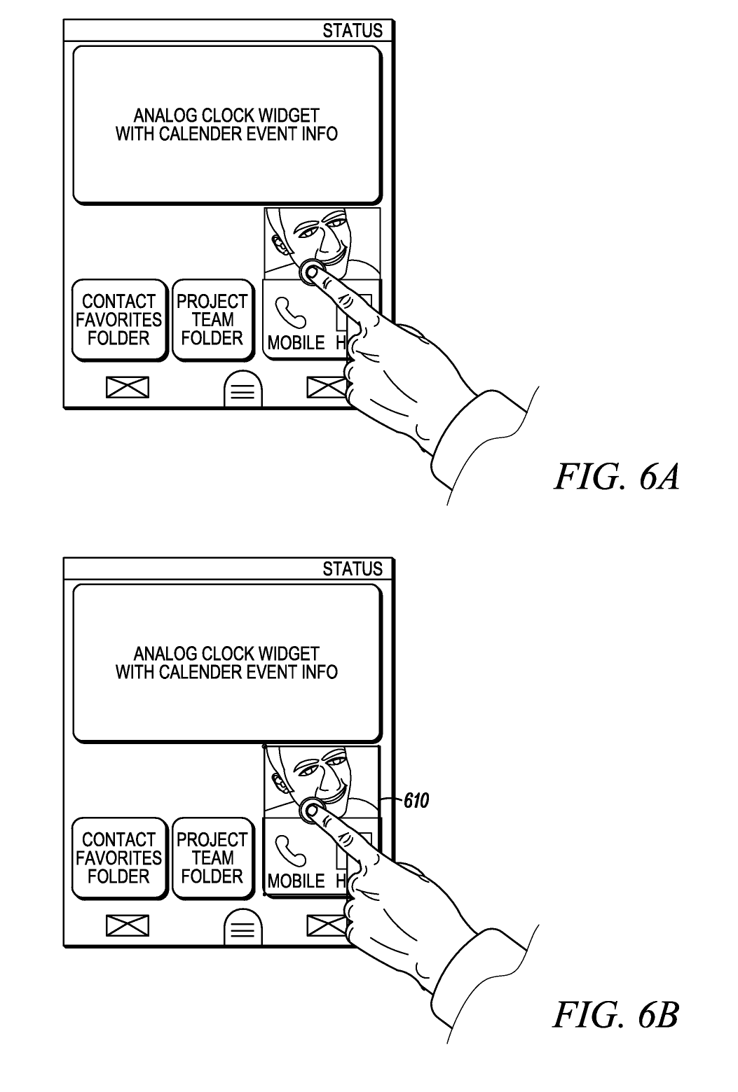

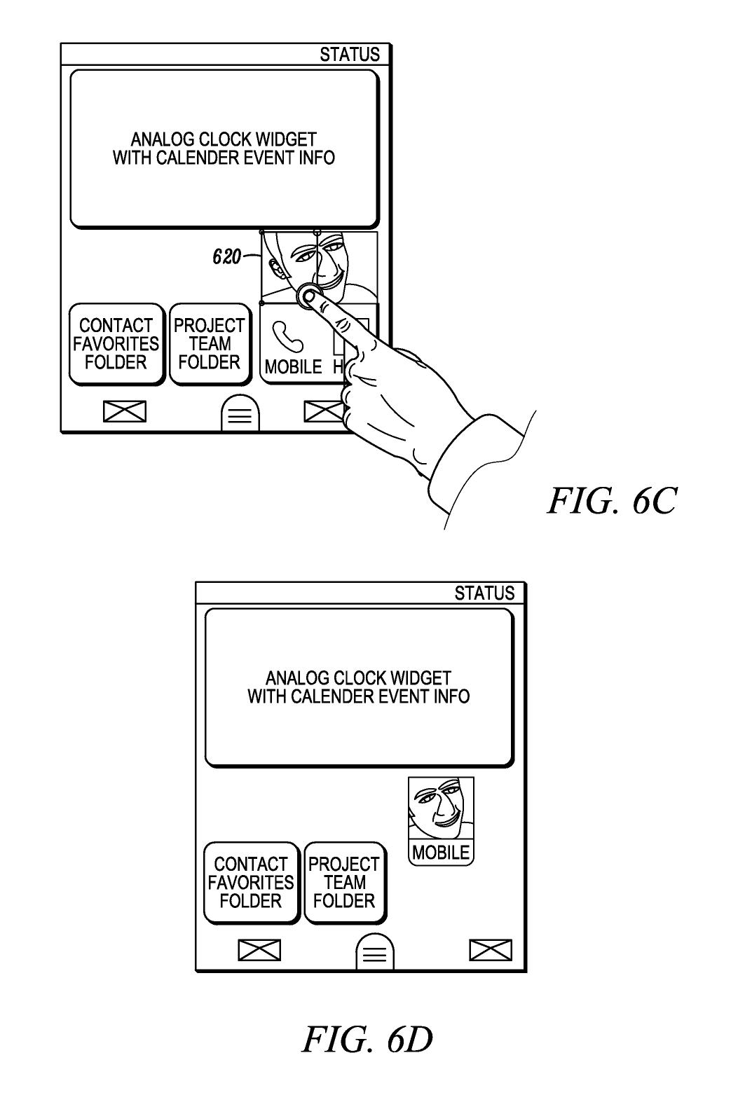

Referring to FIG. 6A through 6D, there are shown screen views illustrating an example storyboard for resizing another contact widget in accordance with the present invention. For this example, the contact widget is resized to one-quarter its original area. At FIG. 6A, the input component detects selection of the contact widget by a user and activation of the resizing operation. For this step, a user may touch the widget to activate the resizing operation. In FIG. 6B, the display may provide an acknowledgment of the activation of the resizing operation. For example, as shown in FIG. 6B, the outer border 610 of the contact widget may be visually represented. In FIG. 6C, the user may contact a part of the outer border, such as its lower-right corner and move to a different position, such as towards the center of the contact widget, such resizing the outer boundary 620 to shorten the width in half and shorten the length in half. As a result, the contact widget is then one-quarter its original size as shown in FIG. 6D. It may be noted that the task representations of the contact widget has been reduced from 2 representations (Mobile and Home in FIGS. 6A-6C) to 1 representation (Mobile in FIG. 6D) due to the reduced size of the contact widget.

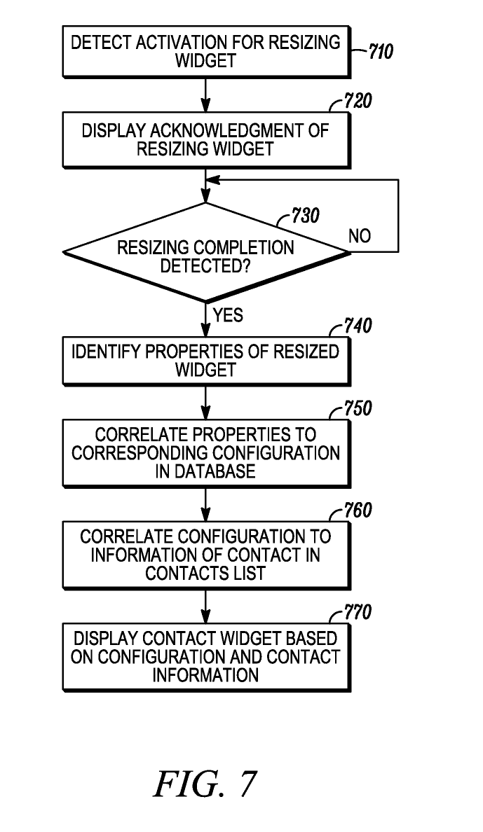

Referring to FIG. 7, there is shown a flow diagram representing the example storyboard of FIGS. 6A through 6D. There is provided a method of an electronic device for providing a visual representation of a contact widget, wherein the electronic device includes a processor, a display and an input component associated with the display. The input component provides detecting activation for resizing a contact widget at step 710 and the display acknowledging the activation of the resizing function at step 720. The touch screen or other input component may the detect user input indicating resizing of the contact widget at the display at step 730. This step of detecting resizing of the contact widget at the display may include identifying the widget contact. This step may further include changing the contact widget from a first widget configuration to a second widget configuration different from the first widget configuration. For example, the input component may detect a user gesture initiated at a first location proximate an outer boundary of the contact widget and directed to a second location different from the first location. Changing the contact widget from a first widget configuration to a second widget configuration different from the first widget configuration may include changing a width of the contact widget, changing a length of the contact widget, both width and length, or any other method of changing the shape and/or size of the outer boundary of the contact widget.

After detecting that the contact widget has been resized, the processor identifies widget properties of the contact widget at step 740. Identifying widget properties of the contact widget may include identifying a width of the contact widget, a length of the contact widget, both width and length, or any other measurement of the shape and/or size of the outer boundary of the contact widget after being resized.

The electronic device, such as one of its processors, may determine a widget configuration corresponding to the widget properties at step 750. The widget configuration may define a maximum quantity of task representations associated with the contact widget. For one embodiment, the electronic device may compare the widget properties to widget configurations in a database and determine the widget configuration correlating with the widget properties. For another embodiment, the electronic device may calculate the widget configuration based on one or more predetermined rules stored in a memory of the electronic device.

The electronic device, such as one of its processors, may determine one or more task representations to be provided with the contact widget at step 760. The quantity of task representations to be provided with the contact widget may be no greater than the maximum quantity of task representations associated with the contact widget. For one embodiment, the processor may determine the one or more task representations to be at least one of a phone number, a text message, an email message, an instant message, or a short message service message. Thus, a task representation may include, but is not limited to, calling, texting, emailing, instant messaging, looking up a person's address in a mapping application, viewing the full details of the contact record in the contacts application, viewing communications history with the contact, viewing recent social networking status updates of the contact, and, for each social networking ID associated with the contact, viewing a list of actions available with the social network. Examples of viewing a list of actions available with the social network include, but are not limited to, viewing their profile on the social network, adding a comment to their public profile, and direct messaging the contact within that social network. These actions may vary over time, depending on how the electronic device integrates with each social network and the available features.

Finally, the display may provide the contact widget based on the widget configuration and the task representation(s) to be provided with the contact widget at step 770. For one embodiment, the display may provide the widget configuration, which may includes at least one position for receiving task representations, and display the task representation(s) at the one or more positions for receiving task representations. For another embodiment, the display may provide the widget configuration at the display in which the widget configuration includes one or more positions for receiving an image corresponding to a contact identifier of the contact widget, and display the image at the position(s) for receiving the image corresponding to the contact identifier of the contact widget. For yet another embodiment, the display may provide the widget configuration at the display, the widget configuration includes positions for receiving task representations, determine whether the maximum quantity of task representations associated with the contact widget exceeds the quantity of task representations to be provided with the contact widget, and display at least one position of the positions without any task representation in response to determining that the maximum quantity of task representations associated with the contact widget exceeds the quantity of task representations to be provided with the contact widget.

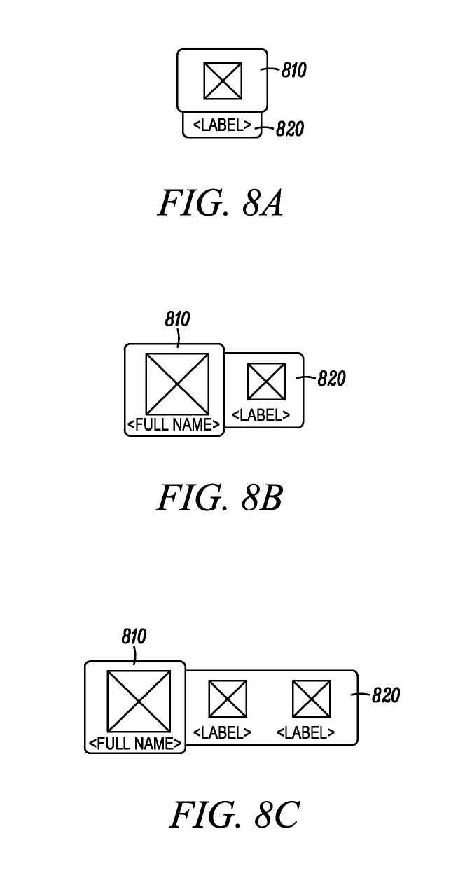

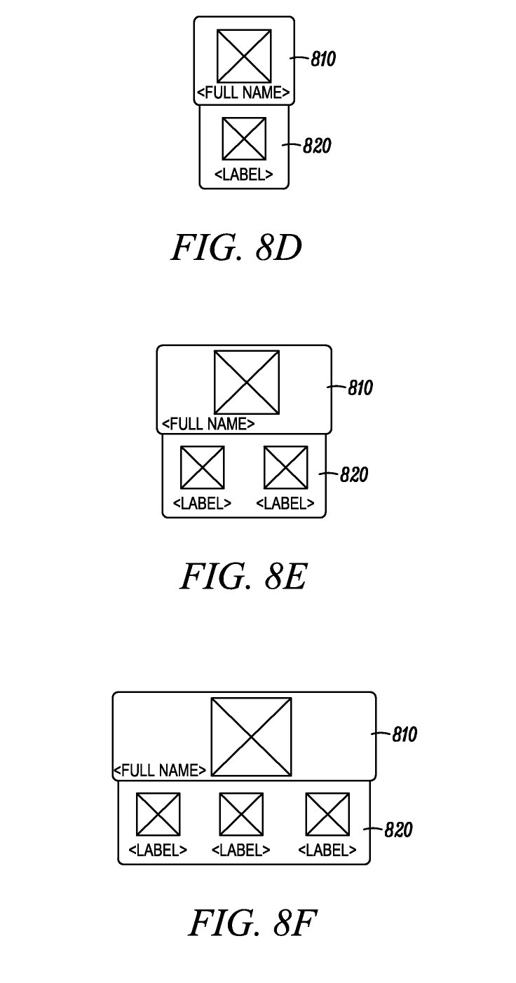

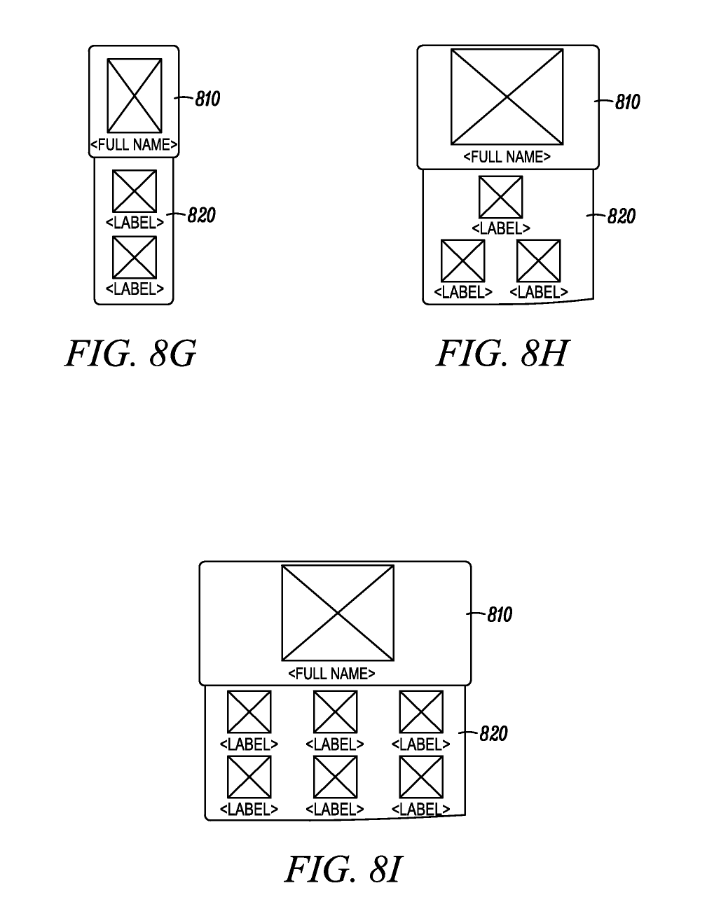

Referring to FIG. 8A through 8I, there are shown screen views illustrating example contact widget specifications in accordance with the present invention. As stated above, the processor may determine a widget configuration corresponding to the widget properties. The processor may compare the widget properties to widget configurations in a database and determining the widget configuration correlating with the widget properties. FIG. 8A through 8I illustrate examples of the type of widget configurations which may be represented in the database. For example, FIGS. 8A, 8E and 8I represent widget configurations that are substantially square in shape. If the widget properties represent a substantially square widget, after being resized, then one of these substantially square widget configurations may be considered. To select among these substantially square widget configurations, the processor may select the configuration having the most similar size to the widget properties. Similarly, the processor may consider the widget configurations represented by FIGS. 8B, 8C and 8F for widget properties representing wider widgets, and the processor may consider the widget configurations represented by FIGS. 8D, 8G and 8H for widget properties representing taller widgets.

It should be noted that each widget configuration includes an image section 810 and one or more task representation sections 820. Although these sections are available for all widget configurations, they are not necessarily “occupied” by their respective content. For example, the image section 810 may be blank or include a default graphic instead an image, if the image has not been selected or is not available. Also, the task representation section 820 may be blank or include a default graphic is less than the maximum quantity of task representations has been selected or are not available. It is to be understood that reference to default graphics, images or appearances as describe in this application include blank representations as well as non-blank representations.

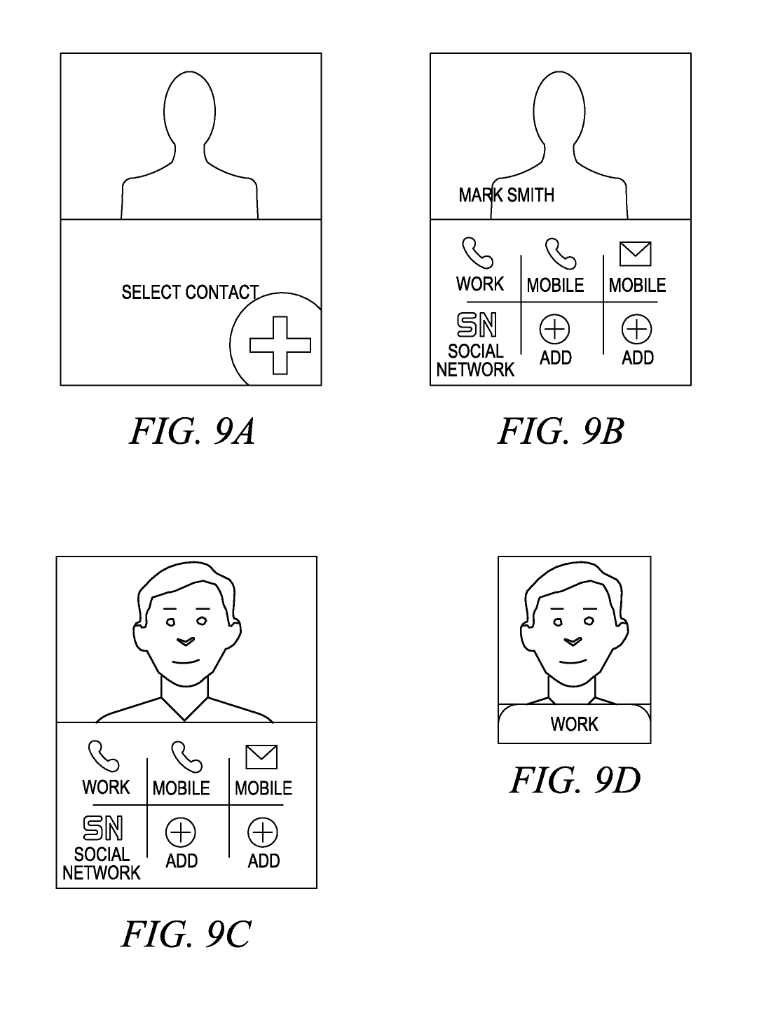

It should also be noted that some widget configurations have a maximum quantity of task representations of one, such as FIGS. 8B and 8D, some widget configurations have a maximum quantity of task representations of two, such as FIGS. 8C, 8E and 8G, some widget configurations have a maximum quantity of tasks representations of more than two, such as FIGS. 8F, 8H and 8I, and some widget configurations may not have space for any task representations, such as FIG. 8A. It should be noted that the widget configuration of FIG. 8A is capable of showing a single task representation, if any are specified, for example, as illustrated in FIG. 9D. Thus, the widget configuration and, thus, the corresponding or associated widget properties, determine how many task representations may be provided for each contact widget. Optionally, each contact widget may include a name label within each image section 810 and/or a task label for each task representation section 820.

Referring to FIG. 9A through 9D, there are shown screen views illustrating example visual representations of other contact widgets in accordance with the present invention. FIG. 9A represents a contact widget in which the image section includes a default graphic and the task representation section is blank. FIG. 9B represents a contact widget in which the image section includes a default graphic with a name label and the task representation section includes four task representations, including corresponding task labels, out of the maximum quantity of task representations of six. The remaining two positions for task representations include a default graphic, i.e., a plus sign with the word “Add”, which may be updated by the user if the additional contact identifiers are available in a contact list or may be left “as is”. FIG. 9C represents a contact widget similar to FIG. 9B, except that the image section includes an image without a name label. FIG. 9D represents a contact widget in which the image section includes an image without a name label and the task representation section includes a task label without any task representations.

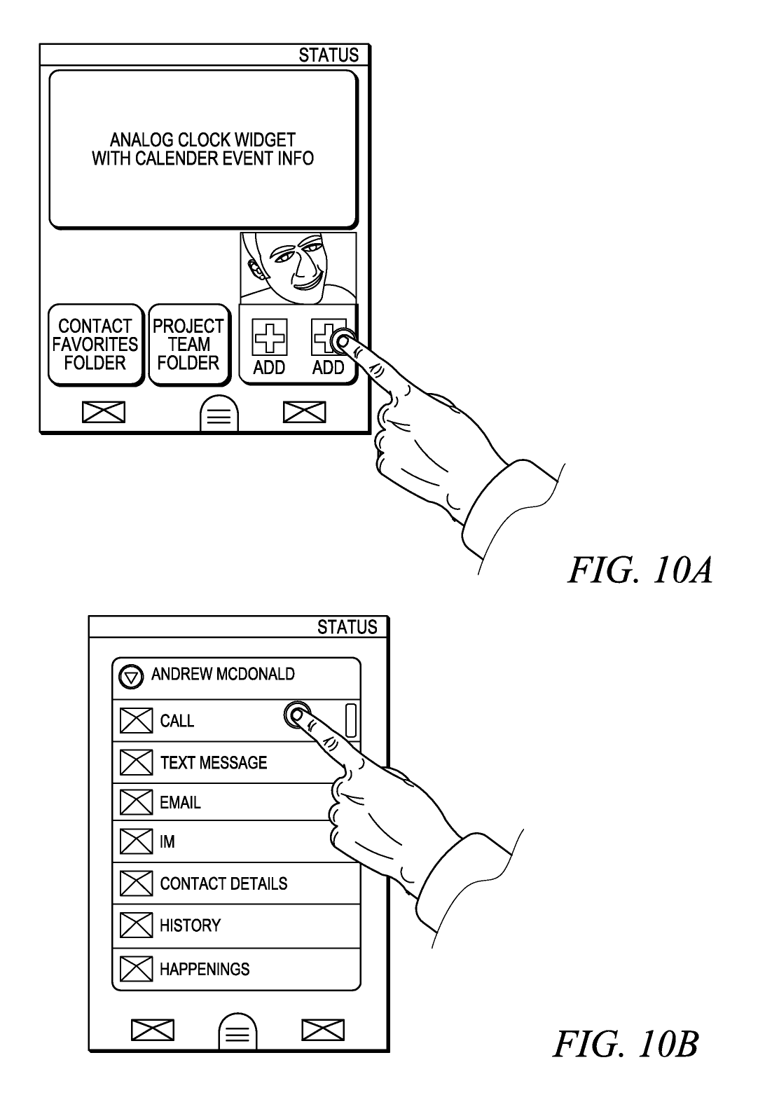

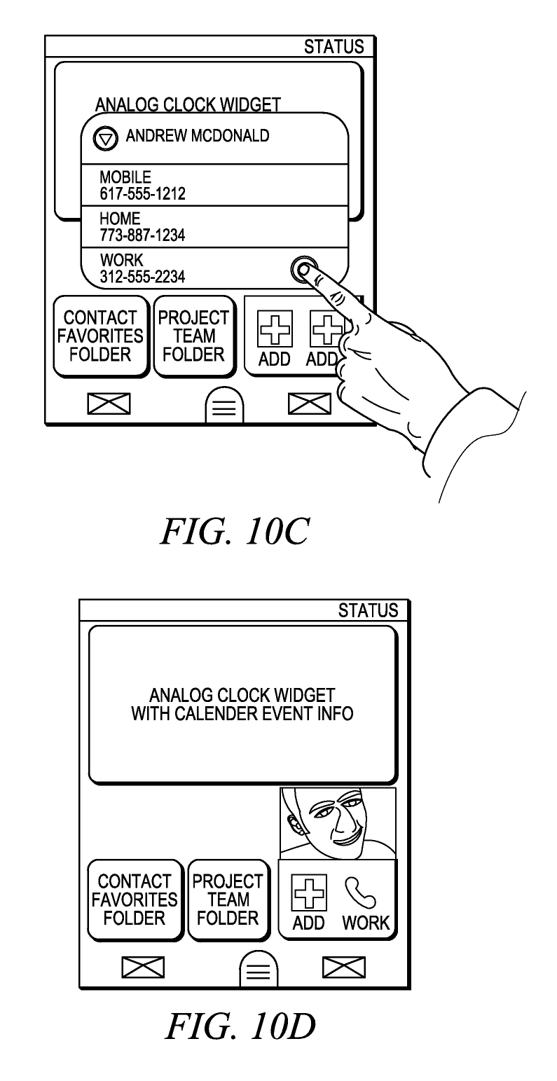

Referring FIG. 10A through 10D, there are shown screen views illustrating an example storyboard for setting a widget action of another contact widget in accordance with the present invention. For widgets having a maximum quantity of task representations exceeding the quantity of task representations provided, such as the contact widgets illustrated in FIGS. 9B and 9C, a widget action may be added to one of the unassigned or available positions. At FIG. 10A, the input component detects selection of the contact widget by a user and activation of the setting operation. For this step, a user may touch and hold an open or unassigned position of the widget action to activate the setting operation. FIG. 10B illustrates how the display may provide the available communication categories available for the selected contact widget. As shown in FIG. 10C, the input component may detect selection by a user of a particular task set to the open or unassigned position of the contact widget. FIG. 10D illustrates the contact widget with one of its formerly unassigned positions assigned to a particular task, represented by a phone representation and the label “Work”.

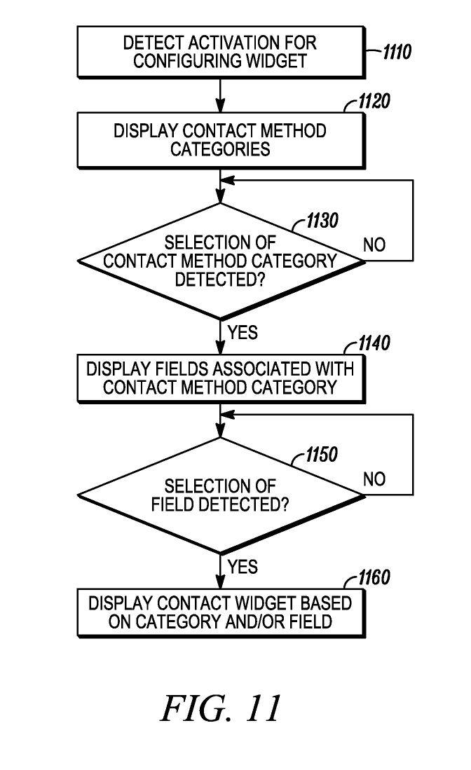

Referring to FIG. 11, there is shown a flow diagram representing the example storyboard of FIGS. 10A through 10D. The input component detects an activation of the setting operation at step 1110. The display provides a contact widget including an assigned representation of an assigned task at a first position and a default representation at a second position at step 1120. The input component detects selection of the default representation associated with the contact widget at step 1130. Next, the display provides tasks associated with the contact widget at step 1140. The input component then detects selection of a particular tasks of the tasks at step 1150. Thereafter, the processor determines a particular representation corresponding to the particular task, and the display provides the particular representation corresponding to the particular task at the second position at step 1160.

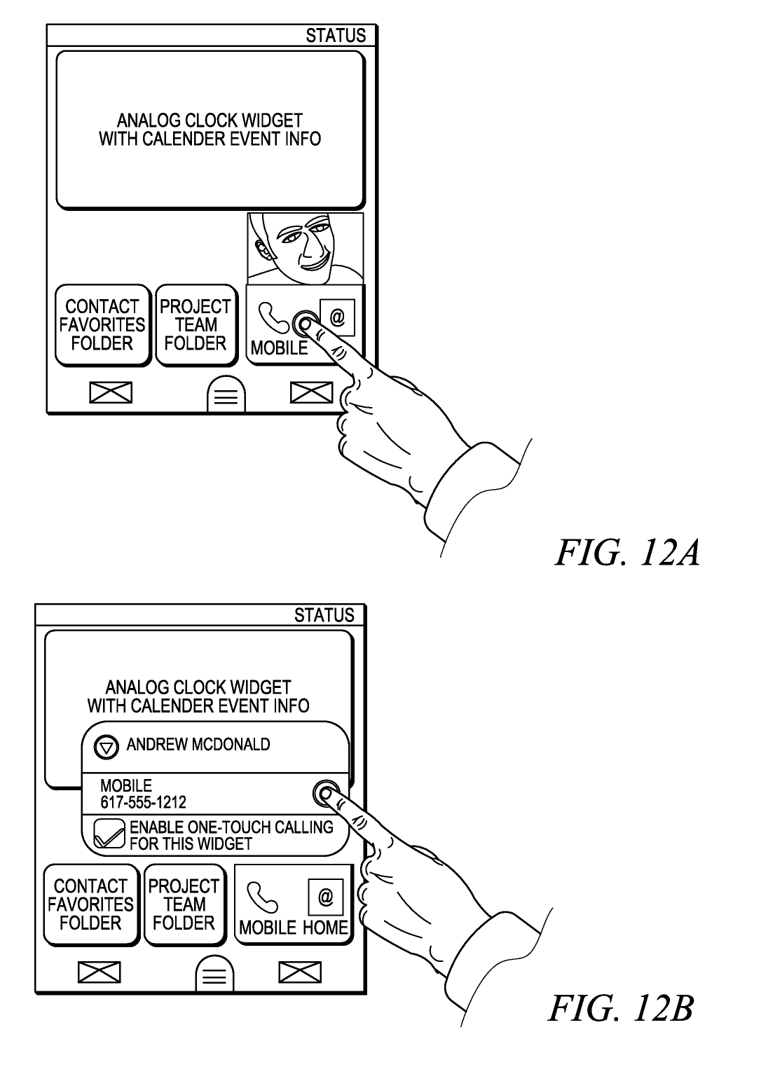

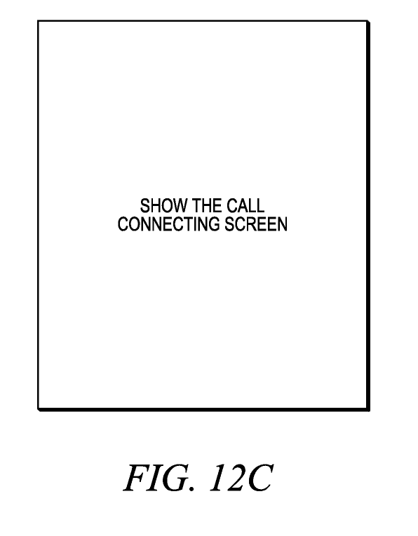

Referring to FIGS. 12A through 12C, there are shown screen views illustrating an example storyboard for making a call in accordance with the present invention. At FIG. 12A, the input component detects selection of the contact widget by a user and activation of the activation operation. For this step, a user may touch the contact widget above the widget task to activate the activation operation. FIG. 12B illustrates how the display may provide the available tasks available for the selected contact widget. As shown in FIG. 12B, the input component may detect selection by a user of a particular task. FIG. 12C is a general representation (not actual) of a communication operation being performed as a result of this activation operation.

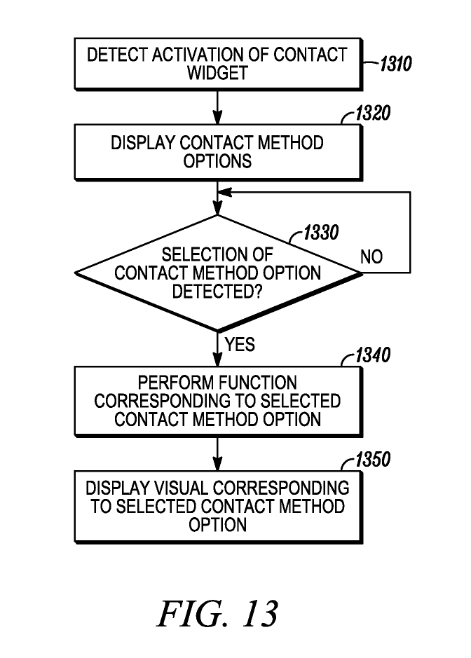

Referring to FIG. 13, there is shown a flow diagram representing the example storyboard of FIGS. 12A through 12C. At FIG. 13A, the input component detects selection of the contact widget by a user and activation of the setting operation at step 1310. The display provides a plurality of tasks associated with the contact widget at step 1320. The input component detects selection of a particular task of the tasks at step 1330. The processor may perform a communication function corresponding to the particular task, at step 1340, in response to detecting selection of the particular task. The display provides a task representation associated with performing the communication function to the particular task at step 1350. Steps 1340 and 1350 may occur in any order or simultaneously.

While the preferred embodiments of the invention have been illustrated and described, it is to be understood that the invention is not so limited. For example, although the above description refers to touch input and touch sensors, the present invention may be practiced with non-touch-sensitive input components, such as the other input components described above. Numerous modifications, changes, variations, substitutions and equivalents will occur to those skilled in the art without departing from the spirit and scope of the present invention as defined by the appended claims.

What is claimed is:

1. A method of an electronic device for providing a visual representation of a contact widget, wherein the electronic device includes a display and an input component associated with the display, the method comprising:
displaying, at the display, a contact widget including a plurality of positions for task representations;
detecting, at the input component, selection of a particular position of the contact widget;
detecting, at the input component, selection of a particular task of a contact list associated with the contact widget; and
displaying, at the display, a representation of the particular task at the particular position.

2. The method of claim 1, wherein the task representations include at least one task associated with a communication task.

3. The method of claim 2, wherein the communication task includes at least one of a phone number, a text messages, an email, an instant message, and an SMS.

4. The method of claim 1, wherein the task representations include at least one task associated with a non-communication task.

5. The method of claim 1, wherein displaying a contact widget including a plurality of positions for task representations includes displaying at least one unassigned representation that is not associated with any task of the contact list.

6. The method of claim 5, wherein the particular position of the contact widget is associated with the unassigned representation that is not associated with any task of the contact list.

7. The method of claim 1, wherein:
the contact widget includes an image associated with the contact widget;
displaying a contact widget includes displaying the image as part of the contact widget.

8. An electronic device for providing a visual representation of a contact widget comprising:
a display supported by the device, the display providing the contact widget including a task representation;
a memory supported by the device, the memory storing a contact associated with the contact widget, wherein the task representation corresponds to a task of the contact;
a processor coupled to the display and the memory, wherein the processor updates the task representation in response to determining that the task of the contact corresponding to the task representation has been changed.

9. The electronic device of claim 8, wherein the processor instructs the display to change the task representation to a default appearance in response to determining that the task of the contact corresponding to the task representation has been removed from the contact.

10. The electronic device of claim 8, wherein the processor instructs the display to change the contact widget to a default appearance in response to determining that the contact corresponding to the task representation has been removed from a contact list including the contact.

11. The electronic device of claim 8, wherein the display provides an image as part of the contact widget, the image being associated with the contact widget.

12. The electronic device of claim 8, wherein the processor instructs the display to change the image to a default appearance in response to determining that a second image of the contact corresponding to the image has been removed from the contact.

13. A method of an electronic device for providing a visual representation of a contact widget comprising:
displaying, at a display, a contact widget including a plurality of positions for task representations, wherein each task representation is associated with a priority, and the task representations are sorted in a particular order based on the priorities of the task representations relative to each other.

14. The method of claim 1, wherein task representations associated with a task of a contact have a higher priority than task representations that are not associated with a task of the contact.

15. The method of claim 1, further comprising:
reducing a quantity of positions of the plurality of positions; and
omitting one or more task representations having the priority that is the lowest among the priorities of the task representations.
